(19) United States
(12) Patent Application Publication
(10) Pub. No.: US 2014/0094940 A1
(43) Pub. Date: Apr. 3, 2014

(54) SYSTEM AND METHOD OF DETECTION OF A MODE OF MOTION

(71) Applicants: Saeed S. Ghassemzadeh, Andover, NJ (US); Lusheng Ji, Randolp, NJ (US); Robert Raymond Miller, II, Convent Station, NJ (US); Behtash Babadi, Allston, MA (US); Vahid Tarokh, Cambridge, MA (US)

(72) Inventors: Saeed S. Ghassemzadeh, Andover, NJ (US); Lusheng Ji, Randolp, NJ (US); Robert Raymond Miller, II, Convent Station, NJ (US); Behtash Babadi, Allston, MA (US); Vahid Tarokh, Cambridge, MA (US)

(21) Appl. No.: 13/631,561

(22) Filed: Sep. 28, 2012

(51) Int. Cl. G06F 19/00

(52) U.S. Cl. 700/91

(57) ABSTRACT

A method includes processing sensor data received from one or more sensors based on the one or more signatures to produce processed data and determining a mode of motion associated with a movement of a user based on the processed data.

### FIELD OF THE DISCLOSURE

The present disclosure is generally related to detection of a mode of motion.

### BACKGROUND

As people age, motor skills (i.e., coordination, muscle strength, and balance) tend to deteriorate. As motor skills deteriorate, falls may become a more common problem. Injuries resulting from a fall may require emergency treatment and may also render the individuals incapable of calling for help. Recovery from these types of injuries (e.g., bone fractures) can require lengthy and costly treatment, may severely impact the individual's quality of life, and may contribute to other factors that lead to a decline in the individual's health.

Some people use a wireless device in the form of a pendant or other portable device that includes communication capability. Such pendants typically have an emergency alert button. When a person is in distress and needs assistance, such as due to a fall or other medical condition, the person can press the button to signal a request for help. An issue or concern with such devices is that the user would need to be conscious in order to be aware of their condition and to press the button. Thus, a person that falls and becomes unconscious would not be able to take the action of pressing the button of the pendant in order to request the emergency assistance. Another problem with such devices is that they are small and portable and may be lost easily or may not be close to the person at the time of the fall. Additionally, the person in need of such devices may forget to have the emergency device with them at all times, such as when they are sleeping, or other times during the day.

Video monitoring systems may also be used for detecting potential medical emergencies, such as falls. In such systems, video cameras may be placed in multiple locations within a residence or managed care facility. The captured video may be communicated to a remote monitoring station that may be monitored by medical personnel for conditions indicating an emergency situation, such as a fall. While remote video monitoring may be useful, it is limited to locations where cameras are present. Additionally, remote video monitoring may intrude into the person's privacy. Further, many cameras would be required to cover all areas within a manage care facility or a residence and the cost of personnel and equipment to monitor the video cameras on a 24/7 basis could be very expensive.

### BRIEF DESCRIPTION OF THE DRAWINGS

FIG. 1 is a block diagram of an illustrative embodiment of a system to detect a mode of motion;

FIG. 2 is a block diagram of another illustrative embodiment of a system to detect a mode of motion;

FIG. 3 is an illustrative embodiment of encoded sensor data for use with a system to detect a mode of motion;

FIG. 4 is a block diagram of another illustrative embodiment of a system to detect a mode of motion;

FIG. 5 is a flowchart of a method of detecting a mode of motion; and

FIG. 6 is a block diagram of an illustrative embodiment of a computer system operable to support the various methods, systems, and computer readable media disclosed with respect to FIGS. 1-5.

### DETAILED DESCRIPTION

The way a person walks is known as a gait and may be divided into two phases, a stance phase and a swing phase. The stance phase corresponds to an interval in which the person's foot is on the ground and may account for approximately sixty percent (60%) of the person's gait. The swing phase corresponds to an interval in which the person's foot is not in contact with the ground and may account for approximately forty percent (40%) of the person's gait.

The stance phase may further be divided into four (4) sub-phases: 1) heel strike, 2) mid-stance, 3) heel off, and 4) toe off. During the heel strike phase the person's heel contacts the ground and then the foot comes to rest flat on the ground. Initially the person's weight is distributed primarily onto the heel of the foot and as the remaining portion of the foot comes into contact with the ground, the weight is then distributed across the entire foot. When one foot is in the heel strike phase, the other foot may be in a different phase of the gait and some of the person's weight may be distributed on the other foot during that time. During the mid-stance phase both of the person's legs are next to each other. Typically, during the mid-stance phase, one foot is resting flat on the ground (e.g., the foot that was previously in the heel strike phase) and the other foot is in, or is entering, the swing phase. When in the mid-stance phase, the person's weight may be distributed across the foot from the ball to the heel. During the heel off phase, the person's heel leaves the ground and the person's weight is distributed towards the ball of the person's foot. During the toe off phase, the person's foot leaves the ground and begins to enter the swing phase.

The swing phase may be divided into two (2) phases: 1) acceleration to mid-swing and 2) mid-swing to deceleration. The acceleration to mid-swing phase corresponds to when the person's foot has left the ground and begins accelerating (i.e., moving forward) in preparation for taking a step. The mid-swing to deceleration phase corresponds to when the person's foot begins to decelerate, and the foot begins to transition into the heel phase.

As a person walks, the person's gait typically follows a repeatable pattern alternating between the stance phase and its sub-phases and the swing phase and its sub-phases. Each one of these phases and sub-phases may cause changes in how the person's weight is distributed across their feet. Sensors may be incorporated into a sensor device (e.g., a shoe) to measure pressure as the user's weight is distributed across each foot. The sensor device may capture the pressure data, which may be used to determine a mode of motion associated with the movement of the user. For example, the sensor data may be transmitted to another device that determines the mode of motion.

In an embodiment, a method includes receiving sensor data at a gateway device from one or more sensors. The sensor data may be related to movement of a user. The method includes processing the sensor data based on one or more signatures to produce processed data, and determining candidate mode of motion data based on the processed data. The method also includes determining a mode of motion associated with the movement of the user based on the candidate mode of motion data.

In a particular embodiment, a system includes a processor and a memory. The memory may store one or more signatures and instructions that, when executed by the processor, cause the processor to perform a method. In this embodiment, the method includes processing sensor data received from one or more sensors based on one or more signatures to produce processed data and determining candidate mode of motion data based on the processed data. The method also includes determining a mode of motion associated with a movement of a user based on the candidate mode of motion data.

In another embodiment, a computer-readable storage device includes instructions that, when executed by a processor, cause the processor to perform a method. In this embodiment the method includes processing sensor data received from one or more sensors based on one or more signatures to produce processed data. The method also includes determining candidate mode of motion data based on the processed data, and determining a mode of motion associated with a movement of a user based on the candidate mode of motion data.

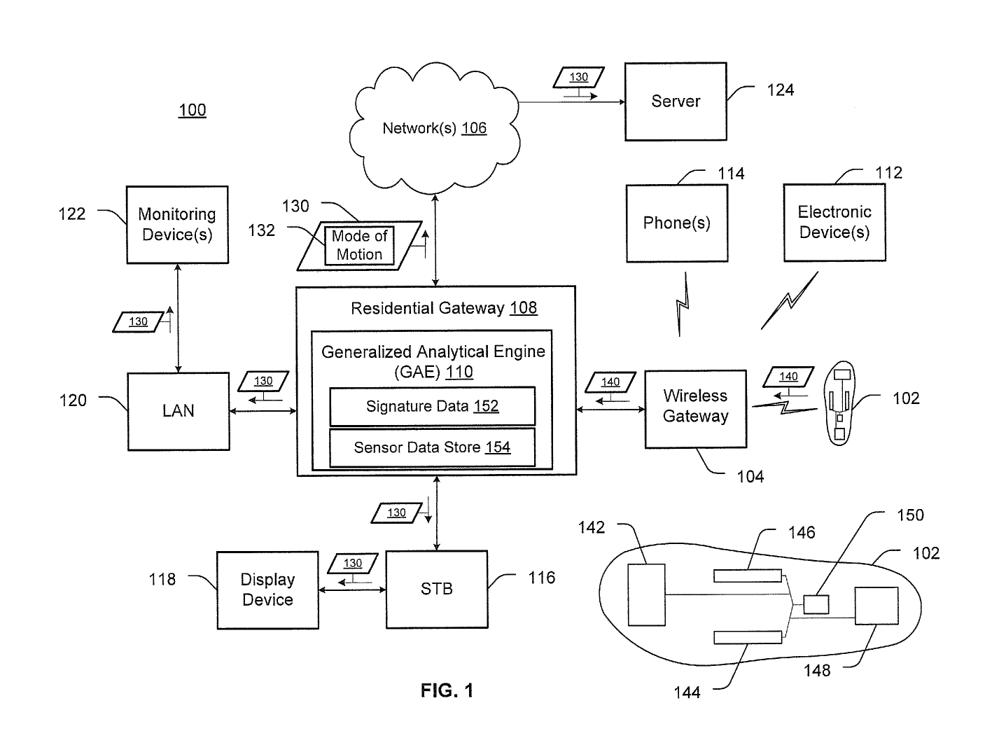

Referring to FIG. 1, a block diagram of an illustrative embodiment of a system to detect a mode of motion is shown and designated 100. The system 100 may include a sensor device 102, a wireless gateway 104, and a residential gateway 108. The wireless gateway 104 may communicate with electronic device(s) 112 and a phone(s) 114 via wireless communication links. The electronic device(s) 112 may include a personal computer, a laptop computer, home appliances, a video device (e.g., a video camera), a voice over internet protocol (VoIP) device, or a combination of these devices. The phone(s) 114 may include a cell phone, a smart phone, other telecommunications devices, or a combination of these devices.

Additionally, the wireless gateway 104 may communicate with the sensor device 102 via a wireless communication link (e.g., a Bluetooth or other wireless data link) and may communicate with the residential gateway 108 via a wired or wireless communication link. In a particular embodiment, the wireless gateway 104 may be a component of the residential gateway 108.

In the embodiment illustrated in FIG. 1, the sensor device 102 includes sensors 142-148. Each of the sensors 142-148 may be configured to generate sensor data that may be used to determine a mode of motion of a user that is using the sensor device 102. In other embodiments, the sensor device 102 may include more sensors or fewer sensors.

In a particular embodiment, the sensor device 102 may include or be included within a pair of shoes. In this embodiment, each of the shoes may include the sensors 142-148. The sensors 142-148 may be arranged to measure pressure at various locations as the user walks while wearing the shoes. For example, as shown in FIG. 1, a first sensor 142 may be incorporated into a toe portion of the shoe and may measure pressure generated by a ball or toe portion of the user's foot as the user walks while wearing the sensor device 102 (e.g., the shoe). To illustrate, when the user's foot transitions from the heel off phase into the toe off phase, the first sensor 142 may measure the pressure generated as the user's weight is transferred toward to the ball of the user's foot and then transferred to the other foot as the toe portion of the foot leaves contact with the ground. The pressure measured by the sensor 142 during the toe off phase may be greater the pressure measured by the sensor 142 during the other sub-phases of the stance phase and the swing phase.

A second sensor 148 may be incorporated into a heel portion of the show and may measure pressure generated by a heel of the user's foot as the user walks. For example, when the user's foot transitions from the mid-swing to deceleration phase into the heel strike phase, the second sensor 148 may measure the pressure generated as the user's weight is transferred to the heel of the user's foot. The pressure measured by the second sensor 148 during the heel strike phase may be greater the pressure measured by the second sensor 148 during the other sub-phases of the stance phase and the swing phase.

A third sensor 144 may be incorporated into an outside arch portion of the shoe and may measure pressure generated by an outside arch portion of the user's foot as the user walks. The fourth sensor 146 may be incorporated into an inside arch portion of the shoe and may measure pressure generated by an inside arch portion of the user's foot as the user walks. The pressure measured by the third and fourth sensors 144, 146 may vary during each gait phase (i.e., the stance phase and the swing phase.

In a particular embodiment, the residential gateway 108 includes a generalized analytical engine 110. The generalized analytical engine 110 may be configured to determine a mode of motion associated with movement of the user. The mode of motion may be determined from among a plurality of modes of motion. The plurality of modes of motion may include walking, running, jumping, climbing, falling, another mode of motion or a combination thereof. As shown in FIG. 1, the sensor device 102 may include a wireless transceiver 150 that is electronically coupled to each of the sensors 142-148. The sensor device 102 may transmit sensor data 140 to the residential gateway 108 via the wireless gateway 104. The sensor data 140 may include information indicative of measurements (e.g., pressure measurements) from one or more of the sensors 142-148. In a particular embodiment, the sensor device 102 may include one or more accelerometers (not shown) to measure a linear acceleration (i.e., velocity) of the sensor device 102 as the user moves. In this embodiment, the sensor data 140 may include linear acceleration data and the generalized analytical engine 110 may determine the mode of motion further based on the linear acceleration data. In an embodiment, the one or more accelerometers may be incorporated within one or more of the sensors 142-148.

To illustrate, during operation, the sensor device 102 may generate the sensor data 140 and may communicate the sensor data 140 to the wireless gateway 104. For example, the wireless transceiver 150 within the sensor device 102 may transmit the sensor data 140 to the wireless gateway 104 via the wireless communication link. The wireless gateway 104 may receive the sensor data 140 and route the sensor data 140 to the residential gateway 108. The residential gateway 108 may receive the sensor data 140 and may provide the sensor data 140 to the generalized analytical engine 110. In an embodiment, the generalized analytical engine 110 may include signature data 152 and a sensor data store 154. The signature data 152 may include a plurality of signatures. Each of the plurality of signatures may correspond to a different mode of motion (e.g., walking, running, jumping, etc.). The generalized analytical engine 110 may process the sensor data 140 based on the signature data 152 to produce processed data. The sensor data store 154 may store the sensor data 140, the processed data, historical sensor data, historical processed data, other data (e.g., sensor data from other users), or a combination thereof.

To generate the processed data, the sensor data 140 may be compared to one or more of the plurality of signatures. The processed data may include a determined mode of motion associated with movement of the user of the sensor device 102. In a particular embodiment, the generalized analytical engine 110 may use one or more statistical processing methods to evaluate the sensor data 140 based on the signature data 152 in order to determine the mode of motion associated with the user of the sensor device 102.

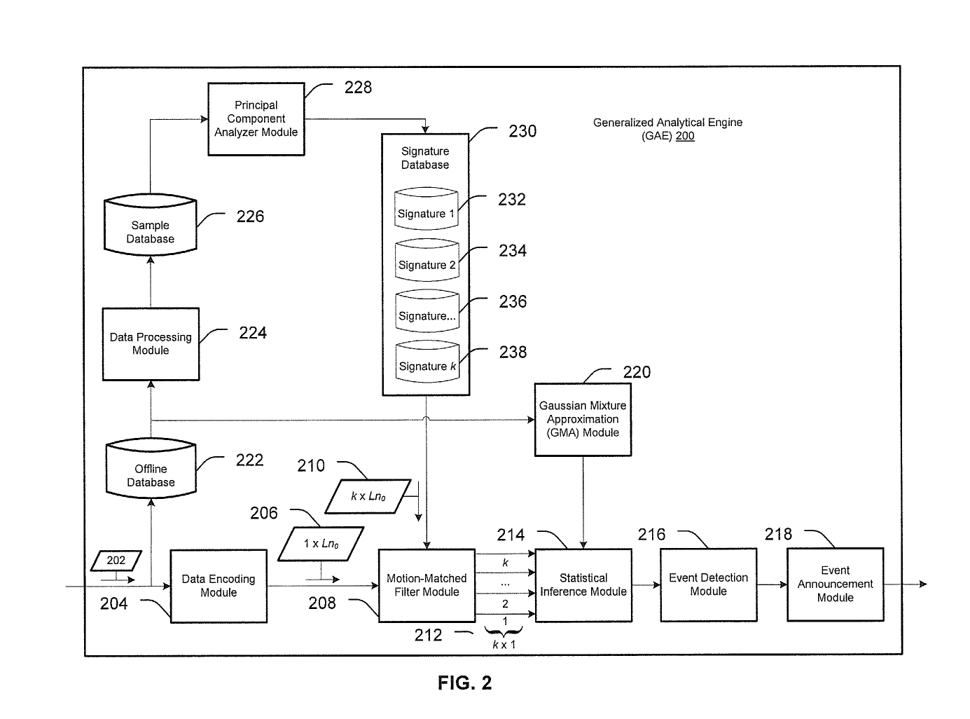

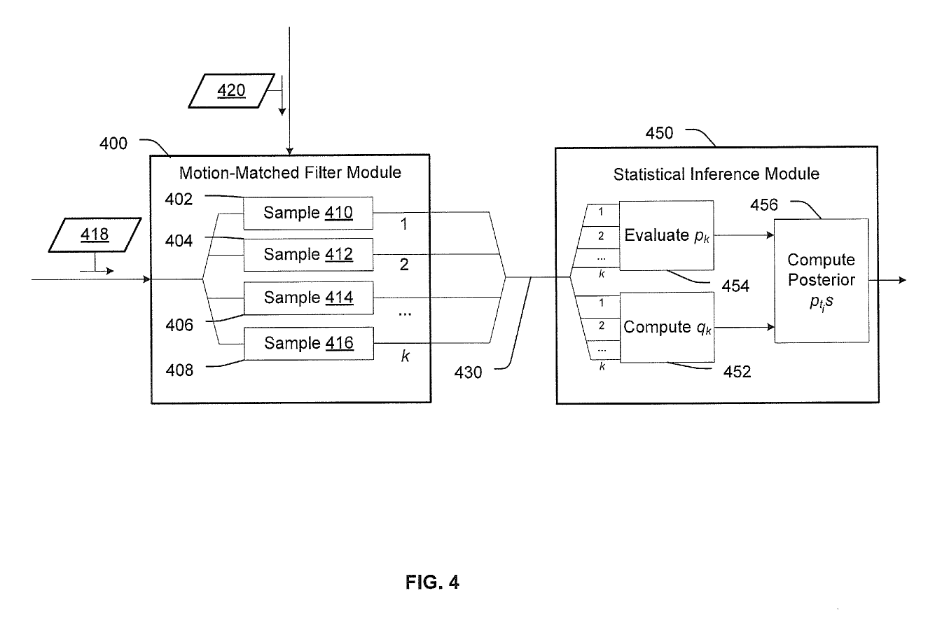

In a particular illustrative embodiment, processing the sensor data 140 based on the signature data 152 may include filtering the sensor data using a matched filter as described with reference to FIGS. 2 and 4 to determine the mode of motion. The generalized analytical engine 110 may determine whether the comparison of the sensor data 140 to a particular signature satisfies a threshold (e.g., 90%). When the comparison satisfies the threshold, the generalized analytical engine 110 may determine that the mode of motion indicated by the sensor data 140 corresponds to the mode of motion associated with the particular signature.

In an embodiment, the residential gateway 108 may be coupled to a server 124 via a network(s) 106. In response to determining the mode of motion, the generalized analytical engine 110 may cause the residential gateway 108 to transmit a message 130 to the server 124. As shown in FIG. 1, the message 130 may include data 132 indicating the determined mode of motion. In a particular embodiment, the server 124 may be associated with a health care services provider (e.g., a doctor's office, a nursing home, an assisted living center, etc.). The server 124 may periodically notify personnel (e.g., nurses or doctors) associated with the health care service provider of the mode of motion indicated by the message 130. In a particular embodiment, the remote server 124 may be part of an information technology system of a medical facility, such as a doctor office, hospital, or other third party healthcare monitoring facility. The server 124 may communicate alerts related to the mode of motion to monitoring personnel, or the server 124 may otherwise cause other devices (not shown) that are coupled or in communication with the server 124 to provide the monitoring personnel with the alerts related to the mode of motion.

In a particular embodiment, the residential gateway 108 may be coupled to a set top box device 116, as shown in FIG. 1. In response to determining the mode of motion, the generalized analytical engine 110 may cause the residential gateway 108 to transmit the message 130, including the data 132 indicating the determined mode of motion, to the set top box device 116 for display at a display device 118 coupled to the set top box device 116. The set top box device 116 may be within a residence and the display device 118 may display an alert associated with the determined mode of motion. For example, when the determined mode of motion indicates that the user of the sensor device 102 is about to fall, is falling, or has fallen, another person within the residence may view the notification via the display device 118 and attend to the user.

Alternatively, or in addition, the residential gateway 108 may be coupled to a monitoring device(s) 122 via a local area network (LAN) 120. In response to determining the mode of motion, the generalized analytical engine 110 may cause the residential gateway 108 to transmit the message 130, including the data 132 indicating the determined mode of motion, to the monitoring device(s) 122. The monitoring device(s) 122 may determine whether to trigger an alarm based on the mode of motion. For example, when the mode of motion indicates that the user of the sensor device 102 is about to fall, is falling, or has fallen, the monitoring device(s) 122 may trigger an alarm (e.g., a beeping sound) to indicate that the user has fallen or is about to fall (e.g., a weight distribution of the user as indicated by the sensor data 140 indicates the user is off balance or unstable). When the mode of motion indicates that a mode of motion other than falling (e.g., walking), the monitoring device(s) 122 may not trigger the alarm. The monitoring device(s) 122 may be within a residence and, when the alarm is triggered, another person within the residence may be notified that the user has fallen and/or may need assistance.

In a particular embodiment, the generalized analytical engine 110 may cause the residential gateway 108 to transmit the message 130 to two or more devices selected from among the set top box device 116, the monitoring device(s) 122, and the server 124. For example, the residential gateway 108 may transmit the message 130 to the monitoring device(s) 122 via the LAN 120 and may communicate the message 130 to the set top box device 116. As another example, the residential gateway 108 may the message 130 to one of the monitoring device(s) 122 or the set top box device 116 and may communicate the message 130 to the server 124 via the network(s) 106. By communicating the mode of motion to a local notification system (e.g., the monitoring device(s) 122) and to a remote notification system (e.g., the server 124), the residential gateway 108, in conjunction with the generalized analytical engine 110, may provide more efficient notification of events (e.g., fall events) that may indicate a user of the sensor device 102 is in need of assistance. Additionally, redundant notification of events to both local and remote monitoring and alert systems may provide an additional layer of efficiency because the local system may be provided notice of the event even when the remote system may not be operating properly and vice-versa. Thus, the system 100 may automatically collect and monitor sensor data and, upon detecting a particular event or possible event associated with the sensor data (e.g., a fall event), the system 100 may automatically alert one or more notification devices or systems to a condition that may require action by one or more parties in order to provide assistance.

In a particular embodiment, the generalized analytical engine 110 may store the sensor data 140 in a sensor data store 154. The sensor data store 154 may be used by the generalized analytical engine 110 to periodically update the signatures stored in the signature data 152. Additionally, or in the alternative, the generalized analytical engine 110 may receive sensor data from a remote location (e.g., the server 124). The received sensor data may be stored in the sensor data store 154 and may be used by the generalized analytical engine 110 to generate the signatures stored in the signature data 152. Although the sensor data store 154 is illustrated as included within the generalized analytical engine 110, in other embodiments, the sensor data store 154 may be at another memory (not shown) of the residential gateway 108, and/or at another location, such as the server 124, for archival purposes.

The wireless gateway 104 may provide the phone(s) 114 and/or the electronic device(s) 112 with access to a data communication network. For example, the phone(s) 114 may send or receive a text message or other data via a data network accessible to the wireless gateway 104 instead of or in addition to sending or receiving the text message or the other data via a wide area data network (e.g., a cellular data communication network). In addition, the electronic device(s) 112 may include a variety of devices that may collect various types of data. Additionally, the electronic device(s) 112 may include home health monitoring devices (e.g., a smart scale, a thermometer, etc.), home appliances (e.g., A/C or air units, light fixtures, etc.), emergency sensor devices (e.g., a smoke detector), or other electronic devices capable of communicating with the wireless gateway 104. Thus, the wireless gateway 104 may be used to send and receive and communicate data to a variety of different devices depending on the particular device and application thereof. While various devices have been described such as appliances, computers, and phones, it should be understood that the wireless gateway 104 may communicate with a variety of other devices to perform different functions depending on the particular application or purpose of the wireless gateway 104. Additionally, the electronic device(s) 112 may include video enabled devices capable of transmitting video data to the wireless gateway 104. The video data may be transmitted to the set top box device 116 for display at the display device 118 or may forwarded to server associated with a remote video monitoring service.

Referring to FIG. 2, an illustrative embodiment of a generalized analytical engine 200 is shown. In a particular embodiment, the generalized analytical engine 200 may be the generalized analytical engine 110 described with reference to FIG. 1. As illustrated in FIG. 2, the generalized analytical engine 200 includes a data encoding module 204, a motion-matched filter module 208, a statistical inference module 214, an event detection module 216, and an event announcement module 218. The generalized analytical engine 200 may also include or have access to (e.g., be coupled to) a Gaussian mixture approximation module 220, an offline database 222, and a signature database 230. The signature database 230 may store a plurality of signatures 232, 234, 236, and 238. For example, the plurality of signatures 232, 234, 236, and 238 may correspond to the signature data 152 of FIG. 1.

The offline database 222 may store a set of pre-recorded (e.g., historical) pressure measurements associated with particular modes of motion. In a particular embodiment, the set of pre-recorded pressure measurements may be generated from a set of users of a sensor device, such as the sensor device 102 described with reference to FIG. 1. Particular users that are included in the set of users may be selected randomly, pseudo-randomly, or based on particular factors, such as factors related to a particular medical condition.

During operation, sensor data 202 may be received at the data encoding module 204. For example, the sensor data 202 may correspond to the sensor data 140 of FIG. 1. The sensor data 202 may represent a data segment of length N, where N represents an observation vector length. Each data segment of length N may include L samples, where each of the L samples corresponds to a sampling of pressure at a corresponding sensor of a sensor device (e.g., the sensors 142-148 of the sensor device 102). Each of the L samples may be associated with a monitoring window size n₀. Thus, the sensor data 202 may correspond to a data segment that includes L samples observed during an observation window of size n₀. For example, in a particular embodiment, the sensor data 202 may be generated by a pair of shoes (e.g., a pair of sensor devices 102), each shoe including a set of four sensors (e.g., the sensors 142-148). Thus, the sensor data 202 may represent segments of length N, including eight (8) samples (e.g., L=8), where each of the eight (8) samples correspond to pressure measurements by the sensors 142-148 at each shoe during a monitoring window n₀. In a particular embodiment, n₀ may correspond to a time window of approximately 1.8 seconds.

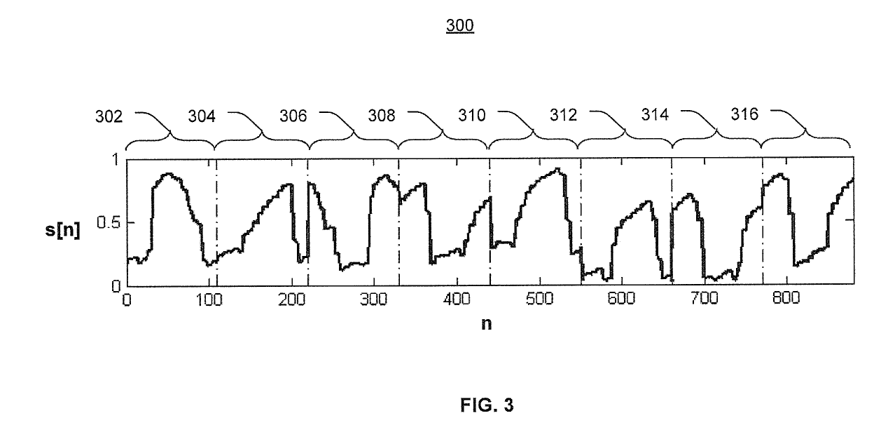

The data encoding module 204, after receiving the sensor data 202, may process the sensor data 202 to produce encoded sensor data 206. As shown in FIG. 2, the encoded sensor data 206 may be include a segment of the L samples corresponding to pressure measurements observed by the sensors of a sensor device (e.g., a pair of shoes) during an observation window of size n₀. In a particular embodiment, processing the sensor data 202 includes encoding the sensor data 202 according to an encoding pattern. In a particular illustrative embodiment, the sensor data 202 may be encoded as described with respect to FIG. 3.

After processing the sensor data 202 to produce the encoded sensor data 206, the data encoding module 204 may provide the processed data 206 to the motion-matched filter module 208. The motion-matched filter module may also receive signature data 210 from the signature database 230. As shown in FIG. 2, the signature database 230 may store a number of signatures k, where k corresponds to the number of modes of motion (e.g., walking, running, jumping, etc.) detectable by the generalized analytical engine 200. For example, the signature database 230 may store a plurality of signatures 232-238, where a first signature 232 corresponds to a first mode of motion and a k^{th} signature 238 corresponds to a k^{th} mode of motion. In a particular embodiment, the signatures 232-238 may be stored as Eigen-functions. As shown in FIG. 2, the signature data 210 may be include k signatures, each of the k signatures including L samples corresponding to pressure measurements observed by sensors of one or more sensor devices (e.g., a pair of shoes) during an observation window of size n₀.

The motion-matched filter module 208 may process the encoded sensor data 206 based on each of the k signatures included in the signature data 210 to produce processed data 212. In a particular embodiment, processing the encoded sensor data 206 based on each of the k signatures includes projecting each of the L samples included in the encoded sensor data 206 onto each of the k signatures to produce the processed data 212. In a particular embodiment, the processed data 212 may include a set of k expansion coefficients. For example, the processed data 212 may comprise a k×1 vector that includes the set of k expansion coefficients, as shown in FIG. 2.

The motion-matched filter module 208 may provide the processed data 212 to the statistical inference module 214. The statistical inference module 214 may receive the processed data 212 and determine candidate mode of motion data based on the processed data 212. In a particular embodiment, the statistical inference module 214 may receive data from the Gaussian mixture approximation module 220 and may determine the candidate mode of motion data based on the processed data 212 and based on the data received from the Gaussian mixture approximation module 220. In a particular embodiment, the candidate mode of motion data may include a set of k posterior probabilities. For example, the candidate mode of motion data may include a k×1 vector that includes the set of k posterior probabilities. Each of the k posterior probabilities may correspond to one of the expansion coefficients included in the processed data 212 and may indicate a likelihood that the mode of motion associated with the expansion coefficient is the mode of motion associated with the sensor data 202. An exemplary illustrative embodiment of a statistical inference module 214 is described with reference to FIG. 4.

The statistical inference module 214 may provide the candidate mode of motion data to the event detection module 216. The event detection module 216 may determine, based on the candidate mode of motion data, a particular mode of motion associated with movement of a user that is using the sensor device that created the sensor data 202. For example, when the candidate mode of motion data includes a k×1 vector including the set of k posterior probabilities, the event detection module 216 may determine whether one or more of the k posterior probabilities exceeds a threshold value (e.g., ninety percent (90%)). When the posterior probability of a particular mode of motion is greater than the threshold value, the event detection module 216 may provide an input indicating the particular mode of motion to the event announcement module 218. The event announcement module 218 may then output the particular mode of motion to another device (e.g., the set top box device 116, the monitoring device(s) 122), or the server 124) in an event announcement (e.g., the message 130 of FIG. 1).

In a particular embodiment, the generalized analytical engine 200 also includes or is coupled to a data processing module 224, a principal component analyzer module 228, and a sample database 226. The principal component analyzer module 228 may determine a set of Eigen-functions based on sample sensor data stored in the sample database 226. For example, the principal component analyzer module 228 may use a mathematical procedure (e.g., principal component analysis) to extract uncorrelated features from a set of correlated observation data. To illustrate, an operator of the generalized analytical engine 200 may generate numerous samples of sensor data associated with a particular mode of motion (e.g., walking) by observing one or more test subjects (e.g., persons) moving according to the particular mode of motion while operating a sensor device (e.g., the sensor device 102). The sample sensor data may be stored at the sample database 226. The principal component analyzer module 228 may determine an empirical Eigen-function for each mode of motion based on the sample sensor data stored at the sample database 226 and the empirical Eigen-functions for each mode of motion may be stored at the signature database 230. In a particular embodiment, the empirical Eigen-functions may be derived by the principal component analyzer module 228 using spectral decomposition of an empirical covariance kernel, as described further with reference to FIG. 4.

In a particular embodiment, the principal component analyzer module 228 may periodically or occasionally update the signatures 232-238 stored at the signature database 230. In a particular embodiment, the data processing module 224 may process sensor data stored at the offline database 222 prior to storing the sensor data at the sample database 226. The data processing module 224 may encode the sensor data stored in the offline database 222 prior to storing the sensor data at the sample database 226. For example, the data processing module 224 may encode the sensor data according to an encoding pattern, such as the encoding pattern described with reference to FIG. 3.

In a particular embodiment, the generalized analytical engine 200 may be configured to detect additional modes of motion that may be identified to within a threshold confidence level. For example, initially the generalized analytical engine 200 may be operable to determine whether the sensor data 202 corresponds to a particular mode of motion selected from walking, running, and jumping. As additional samples of sensor data are obtained (e.g., stored at the sample database 226) for additional modes of motion, such as climbing or falling, the generalized analytical engine 200 may determine additional signatures corresponding to these additional modes of motion using the principal component analyzer module 228. The principal component analyzer module 228 may store these additional signatures at the signature database 230, and the generalized analytical engine 200 may determine whether subsequent sensor data 202 corresponds to one of these additional signatures when determining a mode of motion associated with the subsequent sensor data 202.

As shown in FIG. 2, the generalized analytical engine 200 includes or is coupled to the offline database 222. In response to receiving the sensor data 202, the generalized analytical engine 200 may store the sensor data 202 as raw sensor data (i.e., unprocessed sensor data). In a particular embodiment, the Gaussian mixture approximation module 220 may access the sensor data stored at the offline database 222 to generate Gaussian mixture parameters and may provide the Gaussian mixture parameters to the statistical inference module 214. The statistical inference module 214 may determine the candidate mode of motion based further on the Gaussian mixture parameters as described with reference to FIG. 4.

Referring to FIG. 3, an illustrative embodiment of encoded sensor data for use with a system to detect a mode of motion is shown and designated 300. As shown in FIG. 3, the encoded sensor data 300 includes a plurality of sensor data portions 302-318. In a particular embodiment, the sensor data 300 was generated by eight sensors (not shown). For example, the eight sensors may be incorporated into a pair of sensor devices, such as a pair of shoes, and each of the sensor devices may include four sensors. A first sensor device of the pair of sensor devices may include a first set of four sensors, such as the sensors 142-148, and a second sensor device of the pair of sensor devices may include a second set of four sensors, such as the sensors 142-148. The first sensor device and the second sensor device may each include a wireless transceiver, such as the wireless transceiver 150 of FIG. 1. As the sensors in the first sensor device and the second sensor device generate sensor data (e.g., the sensor data 140 or the sensor data 202), the wireless transceivers may transmit the sensor data to a device that includes or is coupled to a generalized analytical engine, such as the generalized analytical engine 110 or the generalized analytical engine 200.

In a particular embodiment, the device that includes the generalized analytical engine may receive the sensor data as from the first sensor device and the second sensor device separately. The sensor data may be provided to the generalized analytical engine for use in determining a mode of motion associated with a user of the first sensor device and the second sensor device. Prior to determining the mode of motion, the generalized analytical engine may encode the sensor data using a data encoding module, such as the data encoding module 204 described with reference to FIG. 2, to produce encoded data. In a particular embodiment, the encoded sensor data may be the processed sensor data 206 described with reference to FIG. 1.

As shown in FIG. 3, the encoded sensor data 300 includes a plurality of sensor data portions 302-318. First sensor data portions 302, 306, 310, and 314 may correspond to pressure measurement generated by the sensors of the first sensor device, and second sensor data 304, 308, 312, 314 may correspond to pressure measurement generated by the sensors of the second sensor device. In a particular embodiment, the sensor data 302, 304 may correspond to pressure measurements generated by sensors incorporated a first portion (e.g., a heel portion of a shoe) of the first and second sensor devices, respectively, and may represent measurements of pressure generated during movement of a user that is using the first and second sensor devices. The sensor data 306, 308 may correspond to pressure measurements generated by sensors incorporated a second portion (e.g., a toe or ball portion of a shoe) of the first and second sensor devices, respectively, and may represent measurements of pressure generated at the second portion of the first and second sensor devices during movement of the user. The sensor data 310, 312 may correspond to pressure measurements generated by sensors incorporated a third portion (e.g., an inside arch portion of a shoe) of the first and second sensor devices, respectively, and may represent measurements of pressure generated at the third portion of the first and second sensor devices during movement of the user. The sensor data 314, 316 may correspond to pressure measurements generated by sensors incorporated a fourth portion (e.g., an outside arch portion of a shoe) of the first and second sensor devices, respectively, and may represent measurements of pressure generated at the fourth portion of the first and second sensor devices during movement of the user.

Referring to FIG. 4, a particular embodiment of a motion-matched filter module 400 and a statistical inference module 450 for use in determining a mode of motion are shown. As shown in FIG. 4, the motion-matched filter module 400 may receive sensor data 418 and signature data 420. In a particular embodiment, the sensor data 418 may be the encoded sensor data 206 described with reference to FIG. 2, the sensor data 140 described with reference to FIG. 1, an encoded portion of the sensor data 140, or a combination thereof.

During operation, the motion-matched filter module 400 may process the sensor data 418 based on the signature data 420 to produce processed data 430. In a particular embodiment, the signature data 420 may be the signature data 152 described with reference to FIG. 1, the signature data 210 describe with reference to FIG. 2, or a combination thereof. For example, the signature data 420 may include information associated with a plurality of signatures, such as the signatures 232-238 described with reference to FIG. 2. Each of the signatures may correspond to a different mode of motion. To illustrate, a first sample 410 may correspond to a first mode of motion, a second sample 412 may correspond to a second mode of motion, a third sample 414 may correspond to a third mode of motion, and a fourth sample 416 may correspond to a fourth mode of motion. At the processing block 402 the motion-matched filter module 400 may process the sensor data 418 based on the first sample 410. In a particular embodiment, processing the sensor data 418 may include projecting the sensor data 418 onto the first sample 410, and, based on the projection, determining a first expansion coefficient associated with the first sample 410. At processing block 404, the sensor data 418 may be projected onto the second sample 412, and the motion matched filter module 400 may determine a second expansion coefficient associated with the second sample 406. At processing block 406, the sensor data 418 may be projected onto the third sample 414, and the motion matched filter module 400 may determine a third expansion coefficient associated with the third sample 406. At processing block 408, the sensor data 418 may be projected onto the fourth sample 416, and the motion matched filter module 400 may determine a fourth expansion coefficient associated with the fourth sample 416. In a particular embodiment, the motion-matched filter module 400 may receive the sensor data 418 from a data encoding module, such as the data encoding module 204 described with reference to FIG. 2, and the sensor data 418 may have been encoded as described with reference to FIGS. 2 and 3. In a particular embodiment, the sensor data 418 may be encoded in a format suitable for projecting the sensor data 418 onto the samples 410-416. Although four processing blocks and four corresponding samples are shown in FIG. 4, in other embodiments, the motion-matched filter module 400 may include more than four or fewer than four processing blocks and corresponding samples.

The motion-matched filter module 400 may provide the processed data 430 to the statistical inference module 450. In a particular embodiment, the processed data 430 includes the plurality of expansion coefficients determined by projecting the sensor data 418 onto each of the samples 410-416. In a particular embodiment, the processed data 430 may correspond to the processed data 212 described with reference to FIG. 2.

In a particular embodiment, the statistical inference module 450 includes a first processing block 452, a second processing block 454, and a third processing block 456. The processed data 430 may be received at the statistical inference module 450 and provided to both the first processing block 452 and the second processing block 454.

The first processing block 452 may use each of the expansion coefficients in the processed data 430 to evaluate a probability density function for each of the plurality of modes of motion. Similarly, the second processing block 454 may receive each of the one or more expansion coefficients included in the processed data 430 and evaluate a probability density function pₖ. An output of the second processing block 454 and the first processing block 452 may be provided to the third processing block 456. The third processing block 456 may compute a posterior probability for each of the modes of motion. The statistical inference module 450 may output candidate mode of motion data and provide the candidate mode of motion data to an event detection module not shown. The candidate mode of motion data may include a posterior probability for each of the plurality of the modes of motion.

To further illustrate the operations of a generalized analytical engine (e.g., the generalized analytical engines 110, 200) that include the motion-matched filter module 400 and the statistical inference module 450, consider a signal s(t) supported on a interval [0, T], and further suppose that s(t) is one realization of a certain random process. It is known) that any such s(t) can be represented in terms of a set of functions {ψᵢ(t)}ₜ₋₁^{∞} that form a complete ortho-normal basis. Such a representation may be of the form:

$$s ( t ) = {l . i . m .}_{N -> ∞} {\sum }_{i = 1}^{N} {\tilde{s}}_{i} {ψ}_{i} ( t )$$

where {\tilde{s}ᵢ}ᵢ₌₁^{∞} are random variables given by:

$${\tilde{s}}_{i} := {\int }_{0}^{T} s ( t ) {ψ}_{i} ( t ) d t ,$$

and l.i.m. denotes the mean-square convergence:

$${lim}_{N -> ∞} \{ {( s ( t ) - {\sum }_{i = 1}^{N} {\tilde{s}}_{i} {ψ}_{i} ( t ) )}^{2} \} = 0 , 0 \leq t \leq T$$

The basis function may be a Fourier basis that spans the interval [0, T]. However, Fourier analysis may not give a compact representation of a random process. If it is known that the random process has only a few significant components, it is possible to tailor the basis function to capture those components in a concise fashion. In particular, a generalized analytical engine (e.g., the generalized analytical engines 110, 200) may utilize a basis function that gives rise to uncorrelated transform coefficients. That is, if

mᵢ:=E{\tilde{s}ₜ},i=1,2, . . . ,

then the generalized analytical engine (e.g., the generalized analytical engines 110, 200) may seek a condition:

E{(\tilde{s}ₜ−mᵢ)(\tilde{s}ⱼ−mⱼ)}:=λᵢδᵢⱼ,i,j=1,2, . . .

Let μ(t):=ξ{s(t)} be the average motion process time t. A covariance kernel of the motion process may be defined as:

K(t₁,t₂):=E{(s(t₁)−μ(t₁))(s(t₂))−μ(t₂))}0≦t₁,t₂≦T

and it may be shown that the basis function that gives rise to uncorrelated transform coefficients may be obtained from the following integral equation:

λⱼψⱼ(t)=∫₀^{T} [symbol] (t,u)ψⱼ(u)du,j=1,2, . . .

which follows from Mercer's Theorem in spectral theory of compact operators. Additionally, Mercer's Theorem establishes that a series expansion under this basis function converges uniformly to s(t). This procedure may be referred to as Karhunen-Loève (KL) decomposition of a stochastic process.

An unidentified waveform w(t) on the interval [0, T] can be projected onto a group of k Eigen-functions, giving rise to a set of expansion coefficients {\tilde{w}ᵢ}ᵢ₌₁^{k} for some finite positive integer k. Consider a set of categories that span the realizations of the random process under study (e.g., the modes of motion), and denote them by M₁, M₂, . . . , Mₙ, for some finite n. Let P(M_{I}) denote the prior probability that the waveform w(t) belongs to the I^{th} category. Let pₖ^{(l)}(x₁, x₂, . . . ,xₖ) denote the joint probability density function of the k expansion coefficients for the I^{th} category. Then, Bayes rule may be used to obtain the posterior probability that the unidentified waveform w(t) belongs to the I^{th} category as follows:

$$( w ( t ) ∈ {𝓁}_{} \vert {\tilde{w}}_{1} , {\tilde{w}}_{2} , … , {\tilde{w}}_{k} ) = \frac{{p}_{k}^{( 𝓁 )} ( {\tilde{w}}_{1} , {\tilde{w}}_{2} , … , {\tilde{w}}_{k} ) P ( {𝓁}_{} )}{{\sum }_{i = 1}^{n} {p}_{k}^{( i )} ( {\tilde{w}}_{1} , {\tilde{w}}_{2} , … , {\tilde{w}}_{k} ) P ( {i}_{} )}$$

Now assume that different modes of motion are generated by a neural random process denoted by the motion process. Let fₛ be the sampling frequency by which the sensor data is collected, and let N:=[fₛT] for some T. Then, the discrete-time analogue of the KL decomposition will be:

λⱼψⱼ=Kψⱼ,j=1,2, . . . , N

where Kε [symbol] ^{N×N} is a matrix with elements

$${K}_{i , j} := 𝒦 ( \frac{i}{{f}_{s}} , \frac{j}{{f}_{s}} )$$

for i,j=1, 2, . . . , N and ψⱼ:=[ψⱼ(1), ψⱼ(2), . . . , ψⱼ(N)]^{T}ε [symbol] ^{N} for, j=1, 2, . . . , N.

K may be referred to as a covariance matrix of the motion process. The discrete-time basis functions are the Eigen-vectors of the covariance matrix K. To apply this framework to the sensor data, a suitable representation of the sensor data may be defined. Suppose the generalized analytical engine may monitor a window of the incoming sensor data of length n₀ from a total of L sensors, each streaming sensor data s₁[n], s₂[n], . . . , and s_{L}[n]. Then, the effective observation at time n can be represented in the following form:

$$w [ n ] = [ \begin{matrix}\begin{matrix}\underbrace{{s}_{1} [ n - {n}_{0} ] , {s}_{1} [ n - {n}_{0} + 1 ] , … , {s}_{1} [ n ]}_{sensor 1} ; \\ \underbrace{{s}_{2} [ n - {n}_{0} ] , {s}_{2} [ n - {n}_{0} + 1 ] , … , {s}_{2} [ n ]}_{sensor 2} ; … ;\end{matrix} \\ \underbrace{{s}_{L} [ n - {n}_{0} ] , {s}_{L} [ n - {n}_{0} + 1 ] , … , {s}_{L} [ n ]}_{sensor L}\end{matrix} ]$$

The observation vector may therefore be of length N:=Ln₀. This observation encoding format may be used to simultaneously analyze sensor data from different sensors while maintaining the correlation information of different sensors. Now suppose that for each motion category (e.g., walking, running, jumping, etc.), there exists a large sample pool of exemplary sensor data, such as the sample sensor data stored at the sample database 226. Let Pₗ:={s₁^{(l)}, s₂^{(l)}, . . . , s_{N}_{ₗ}^{(l)} be the pool of samples of size corresponding to a motion category} [symbol] ₗ. That is, each sᵢ^{(l)} corresponds to an exemplary observation of a realization of the I^{th} category. The overall sample pool is then given by

$$P := {{⋃}^{n}}_{𝓁 = 1} {P}_{𝓁}$$

with size

$${N}_{total} := {\sum }_{𝓁 = 1} {N}_{𝓁} .$$

The empirical mean and covariance matrix of a motion process may then be defined as:

$$\hat{μ} [ n ] := \frac{1}{{N}_{total}} {\sum }_{{s}_{i} ∈ P} {S}_{i} [ n ] , \\ {\hat{K}}_{n , m} := \frac{1}{{N}_{total} - 1} {{\sum }_{{s}_{i} ∈ P}}^{{N}_{total}} ( {s}_{i} [ n ] - \hat{μ} [ n ] ) ( {s}_{i} [ m ] - \hat{μ} [ m ] )$$

A principal component analyzer module (not shown in FIG. 4) may then perform a spectral decomposition of the empirical covariance matrix to determine the signatures (e.g., the signatures 232-238) according to the following:

$${\hat{ψ}}_{j} = {j}^{th} eigenvector of \hat{K} := {[ {\hat{ψ}}_{j} ( 1 ) , {\hat{ψ}}_{j} ( 2 ) , … , {\hat{ψ}}_{j} ( N ) ]}^{T} ∈ {ℝ}^{N}$$

$$\hat{Ψ} = {( \hat{Ψ} )}_{i , j} = The matrix of eigevectors of \hat{K} ∈ {ℝ}^{N \times N} \\ = {\hat{ψ}}_{j} ( i )$$

In a particular embodiment, the processed data 430 may include a plurality of expansion coefficients \tilde{w}ᵢ, where \tilde{w}ᵢ=[\tilde{w}ᵢ(1), \tilde{w}ᵢ(2), . . . , \tilde{w}ᵢ(k)] corresponds to the processed data 430 generated by the motion-matched filter module 400 at a time tᵢ. At the second processing block 454, the statistical inference module 450 may evaluate each of the expansion coefficients \tilde{w}ᵢ included in the processed data 430 using a probability density function pₖ to determine a probability density pₖ given by the following formula:

$${q}_{k} ( {\hat{w}}_{i} ) = {\sum }_{𝓁 = 1}^{k} \frac{{α}_{𝓁}^{p}}{\sqrt{{( 2 π )}^{k} \vert {\sum }_{𝓁}^{p} \vert}} exp ( - \frac{1}{2} {( {\tilde{w}}_{i} - {μ}_{𝓁}^{p} )}^{T} {( {Σ}_{𝓁}^{p} )}^{- 1} ( {\tilde{w}}_{i} - {μ}_{𝓁}^{p} ) ) ,$$

where pₖ(\tilde{w}ₜ) corresponds to a probability that the sensor data (e.g., the sensor data 418) associated with the expansion coefficient \tilde{w}ᵢ is a particular mode of motion associated with a particular expansion coefficient \tilde{w}ᵢ.

At the first processing block 452, the statistical inference module 450 may evaluate each of the expansion coefficients \tilde{w}ᵢ included in the processed data 430 using a probability density function qₖ to determine a probability density qₖ given by the following formula:

$${q}_{ki} ( {\tilde{w}}_{i} ) = {\sum }_{𝓁 = 1}^{k} \frac{{α}_{𝓁}^{q}}{\sqrt{{( 2 π )}^{k} \vert {\sum }_{𝓁}^{q} \vert}} exp ( - \frac{1}{2} {( {\tilde{w}}_{i} - {μ}_{𝓁}^{q} )}^{T} {( {Σ}_{𝓁}^{q} )}^{- 1} ( {\tilde{w}}_{i} - {μ}_{𝓁}^{q} ) ) ,$$

where qₖ(\tilde{w}ᵢ) corresponds to a probability that the sensor data (e.g., the sensor data 418) associated with the expansion coefficient \tilde{w}ᵢ is a mode of motion other than the mode of motion associated with the particular expansion coefficient. In a particular embodiment, the processing blocks 452, 454 may further evaluate the probability density functions pₖ(\tilde{w}ᵢ) and q^{k}(\tilde{w}ᵢ) based on Gaussian mixture fit parameters {αₗ^{p},ξₗ^{p},μₗ^{p}}ₗ₌₁^{k} and {αₗ^{q},ξₗ^{q},μₗ^{q}}ₗ₌₁^{k}, which may be received from a Gaussian mixture approximation module (e.g., the Gaussian mixture approximation module 220).

An output of each of the processing blocks 452, 454 may be provided to the third processing block 456. The third processing block 456 may then evaluate each of the probability densities pₖ(\tilde{w}ᵢ) and qₖ(\tilde{w}ᵢ) according to Bayes rule using the following formula:

$$P ( \vert {\tilde{w}}_{i} ; {t}_{i} ) = \frac{{p}_{k} ( {\tilde{w}}_{i} ) {P}_{i} ( )}{{p}_{k} ( {\tilde{w}}_{i} ) {P}_{i} ( ) + {q}_{k} ( {\tilde{w}}_{i} ) ( 1 - {P}_{i} ( ) )}$$

to determine a posterior probability that the mode of motion corresponding to the expansion coefficient \tilde{w}ᵢ is the particular mode of motion associated with the sensor data. Thus, the third processing block 456 may generate candidate mode of motion data including a plurality of posterior probabilities, where each posterior probability corresponds to a particular mode of motion. The candidate mode of motion data may be provided to an event detection module (e.g., the event detection module 216) that may determine whether a particular posterior probability corresponding to a particular mode of motion exceeds a threshold. When more than one posterior probability exceeds the threshold, the event detection module may select a mode of motion associated with the posterior probability that exceeds the threshold by the greatest amount. Thus, the motion-matched filter module 400 and the statistical inference module 450 may be used to determine a mode of motion related to movement of a user based on sensor data (e.g., the sensor data 140, 202, 418) generated by a sensor device (e.g., the sensor device 102).

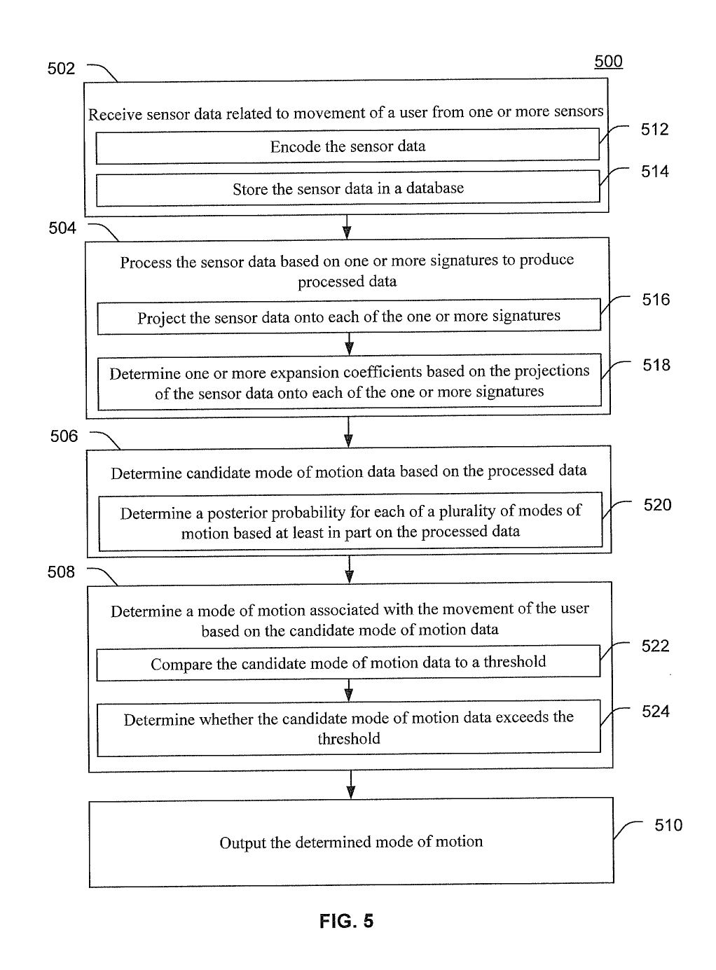

Referring to FIG. 5, a particular illustrative embodiment of a method of determining a mode of motion is shown and designated 500. At 502, the method 500 includes receiving sensor data related to movement of a user from one or more sensors. In a particular embodiment, the sensor data may be received at the generalized analytical engine 110 of FIG. 1 or at the generalized analytical engine 200 of FIG. 2. In a particular embodiment, receiving the sensor data may include encoding the sensor data, at 512, storing the sensor data in a database, at 514, or both. At 504, the method 500 includes processing the sensor data based on one or more signatures to produce processed data. In a particular embodiment, processing the sensor data may include, at 516, projecting the sensor data onto each of the one or more signatures, and, at 518, determining one or more expansion coefficients based on the projections of the sensor data onto each of the one or more signatures.

At 506, the method 500 includes determining candidate mode of motion data based on the processed data. In a particular embodiment, determining the candidate mode of motion data based on the processed data may include, at 520, determining a posterior probability for each of a plurality of modes of motion based at least in part on the processed data. At 508, the method 500 includes determining a mode of motion associated with the movement of the user based on the candidate mode of motion data. In a particular embodiment, determining the mode of motion associated with the movement of the user may include, at 522, comparing the candidate mode of motion data to a threshold, and, at 524, determining whether the candidate mode of motion data exceeds the threshold. In a particular embodiment, the method 500 may include, at 510, outputting the determined mode of motion. For example, if the determined mode of motion corresponds to a falling event than the method 500 may include outputting notification of the falling event, as described with reference to FIG. 1.

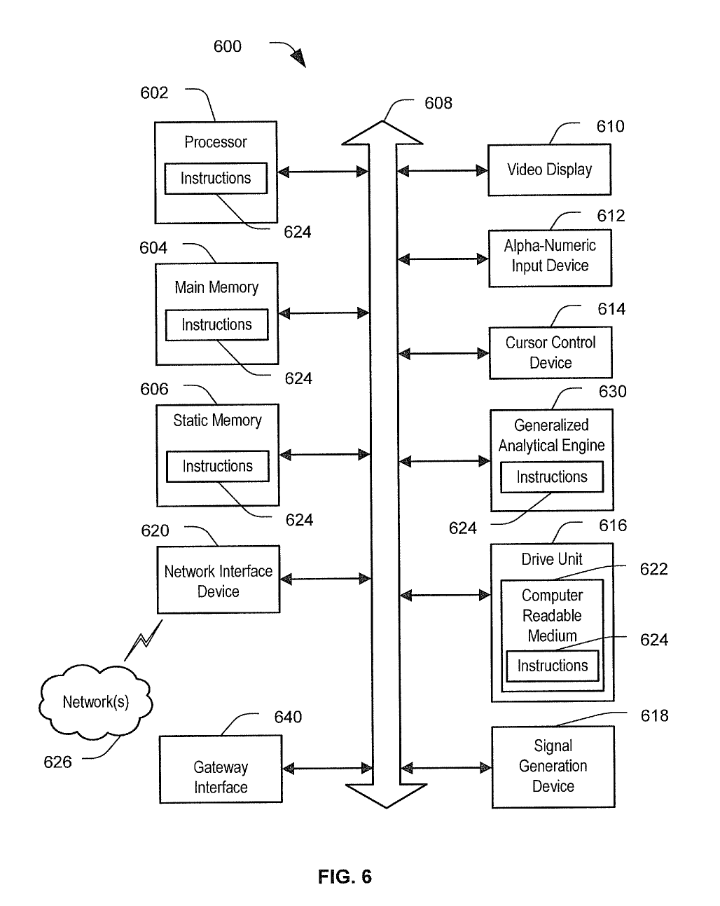

Referring to FIG. 6, an illustrative embodiment of a computer system is shown and designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. For example, the computer system 600 or portions thereof may implement, include, correspond to or be included within any one or more of the monitoring devices, gateways, set-top box devices, servers, electronic devices, phones, databases, or modules illustrated in FIGS. 1,2, and 4.

In a networked deployment, the computer system 600 may operate in the capacity of a server or as a client user computer in a server-client user network environment, or as a peer computer system in a distributed peer-to-peer or network environment. The computer system 600 can also be implemented as or incorporated into various devices, such as a residential gateway, a wireless gateway, personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video, or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, or a solid state display. Additionally, the computer system 600 may include an input device 612, such as a keyboard, and a cursor control device 614, such as a mouse. Such input devices may enable interaction with various GUIs and GUI controls. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein, such as the methods or operations described with reference to FIGS. 1-5. In a particular embodiment, the instructions 624 may reside completely, or at least partially, within the main memory 604, the static memory 606, and/or within the processor 602 during execution by the computer system 600. The main memory 604 and the processor 602 also may include computer-readable media (e.g., a computer-readable storage device). In a particular embodiment, the computer-readable storage medium 622 may store instructions 624 for implementing a generalized analytical engine, such as the generalized analytical engine 110 described with reference to FIG. 1 and the generalized analytical engine 200 described with reference to FIG. 2. Further, the computer-readable storage medium 622 may store instructions 624 operable to encode sensor data as described with reference to FIG. 3 and to process sensor data as described with reference to FIGS. 4 and 5. Alternatively, the system 600 may include a generalized analytical engine 630 that includes a memory storing instructions 624 that, when executed by the processor 602, cause the processor 602 to implement the various systems and methods described with reference to FIGS. 1-5.

In a particular embodiment, the system 600 may includes a gateway interface 640. The gateway interface 640 may enable the system 600 to communicate with one or more gateways (e.g., the wireless gateway 104) and to receive data from one or more devices coupled to the one or more gateways as described with reference to FIG. 1. In another particular embodiment, the system 600 may communicate with a gateway (e.g., the wireless gateway 104) via the network interface device 620.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any non-transitory medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for communication include TCP/IP, UDP/IP, HTML, HTTP, CDMA, TDMA, FDMA, OFDMA, SC-FDMA, GSM, EDGE, evolved EDGE, UMTS, Wi-Max, GPRS, 3GPP, 3GPP2, 4G, LTE, high speed packet access (HSPA), HSPA+, and 802.11x. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method comprising:
receiving sensor data at a gateway device from one or more sensors, and wherein the sensor data is related to movement of a user;
processing the sensor data based on one or more signatures to produce processed data; and
determining a mode of motion associated with the movement of the user based on the processed data.

2. The method of claim 1, wherein the one or more sensors are integrated into at least one shoe and wherein the sensor data is associated with pressure generated during the movement of the user when the user is wearing the at least one shoe.

3. The method of claim 1, wherein the determined mode of motion is one of walking, running, jumping, climbing, and falling, and wherein the determined mode of motion indicates a particular mode of motion related to the movement of the user.

4. The method of claim 3, wherein processing the sensor data comprises:
projecting the sensor data onto each of the one or more signatures; and
determining one or more expansion coefficients based on the projections of the sensor data onto each of the one or more signatures.

5. The method of claim 4, wherein each of the one or more signatures comprises an Eigen-function.

6. The method of claim 4, wherein each of the one or more signatures is associated with the particular mode of motion.

7. The method of claim 4, further comprising determining candidate mode of motion data based on the processed data, wherein determining the candidate mode of motion data comprises determining a posterior probability for each of a plurality of modes of motion based at least in part on the one or more expansion coefficients, wherein each of the one or more expansion coefficients is associated with a different mode of motion, and wherein the candidate mode of motion data includes the posterior probability for each of the plurality of modes of motion.

8. The method of claim 7, wherein the posterior probability for each of the plurality of modes of motion is determined further based on one or more Gaussian mixture fit parameters.

9. The method of claim 7, wherein determining the mode of motion comprises determining whether a particular posterior probability exceeds a threshold.

10. The method of claim 1, further comprising outputting the determined mode of motion.

11. A system comprising:
a processor;
a memory storing:
one or more signatures; and
instructions that, when executed by the processor, cause the processor to perform a method, the method comprising:
processing sensor data received from one or more sensors based on the one or more signatures to produce processed data; and
determining a mode of motion associated with a movement of a user based on the processed data.

12. The system of claim 11, wherein the method further comprises generating the one or more signatures based on historical sensor data.

13. The system of claim 12, wherein the one or more signatures are generated based on the historical sensor data using principal component analysis.

14. The system of claim 12, wherein the method further comprises storing the sensor data in a database.

15. The system of claim 11, wherein the determined mode of motion is one of running, walking, falling, jumping, and climbing.

16. The system of claim 11, wherein the method further comprises outputting the determined mode of motion to a monitoring device, a server, or both, wherein the monitoring device is configured to generate an alert when the determined mode of motion is falling, and wherein the server is associated with a health care services provider.

17. A computer-readable storage device comprising instructions that, when executed by a processor, cause the processor to perform a method, the method comprising:
processing sensor data received from one or more sensors based on one or more signatures to produce processed data;
determining candidate mode of motion data based on the processed data; and
determining a mode of motion associated with a movement of a user based on the candidate mode of motion data.

18. The computer-readable storage device of claim 17, wherein the method further comprises generating the one or more signatures based on historical sensor data.

19. The computer-readable storage device of claim 17, wherein each of the one or more signatures is associated with a particular mode of motion and wherein the method further comprises:
projecting the sensor data onto each of the one or more signatures; and
determining one or more expansion coefficients based on the projections of the sensor data onto each of the one or more signatures, wherein the processed data includes the one or more expansion coefficients;
determining a posterior probability for each of a plurality of modes of motion based at least in part on the one or more expansion coefficients, wherein each of the one or more expansion coefficients is associated with a different mode of motion; and
comparing the posterior probabilities to a threshold, wherein the determined mode of motion is associated with a posterior probability that exceeds the threshold.
